(19) United States
(12) Patent Application Publication
(10) Pub. No.: US 2005/0224003 A1
(43) Pub. Date: Oct. 13, 2005

(54) Method and apparatus for training and feeding an animal using positive reinforcement techniques

(75) Inventors: Sophia Yin, Davis, CA (US); Gregory S. Snyder, Novato, CA (US)

Correspondence Address: BELL, BOYD & LLOYD LLC, P.O. BOX 1135, CHICAGO, IL, 60690-1135, US

(73) Assignee: Sharper Image Corporation, San Francisco, CA (US)

(21) Appl. No.: 10/996,032

(22) Filed: Nov. 23, 2004

Related U.S. Application Data
(60) Provisional application No. 60/561,670, filed on Apr. 12, 2004.
(60) Provisional application No. 60/619,791, filed on Oct. 18, 2004.

(51) Int. Cl. A01K 1/10

(52) U.S. Cl. 119/61.5

(57) ABSTRACT

Embodiments of the present invention are directed to an apparatus and method of effectively training an animal utilizing positive reinforcement techniques. The present invention is directed to a dispensing apparatus which is used in conjunction with a novel training process, whereby the trainer utilizes the dispensing apparatus to timely dispense food pellets when the animal executes a command or complies with an expected behavior. It is preferred that the dispensing apparatus is controlled by a remote control and/or a target wand. The timing at which the apparatus dispenses food pellets, in conjunction with executed command or behavior compliance trains the animal that more of the same is expected and will be rewarded. A novel protocol incorporates the dispensing device to train the animal which is simple and effective for the animal and user.

### CLAIM OF PRIORITY

The present application claims priority under 35 U.S.C. 119(e) to co-pending U.S. Provisional Patent Application Ser. No. 60/561,670, filed Apr. 12, 2004, entitled “Method And Apparatus For Training And Feeding An Animal Utilizing Positive Reinforcement Techniques” (Attorney Docket No. SHPR-01442US0); and U.S. Provisional Patent Application Ser. No. 60/619,791, filed Oct. 18, 2004, entitled “Method And Apparatus For Training And Feeding An Animal Utilizing Positive Behavior Reinforcement Techniques” (Attorney Docket No. SHPR-01442US1), both of which are hereby incorporated herein by reference.

### FIELD OF THE INVENTION

The present invention relates generally to the field of animal training and feeding device and in particular, to a method and apparatus for training an animal utilizing positive reinforcement techniques.

### BACKGROUND OF THE INVENTION

Animals have been domesticated and trained for thousands of years. Undesired behaviors of the animals have been reduced or eliminated by punishment and negative reinforcement. Dogs especially have been taught to heel, sit and lie down by punishing the animals with repetitive leash jerks using metal choke chains or spiked, pinch collars. Dogs have also been taught to retrieve objects through negative reinforcement by pinching their ears and releasing the pressure when they grasp the retrieval object.

For many reasons, punishment and negative reinforcement are disadvantageous to the animal as well as the trainer. By being subjected to punishment and negative reinforcement, the animal quickly associates the unpleasant stimulation with the trainer and learns that there are times when the animal does not need to comply. Such circumstances include when the animal is roaming at liberty or when the trainer is absent. Products are available for these circumstances which allow the trainer to punish the animal at a distance or use shock collars which automatically punish the animal in the owner's absence.

What is needed is an training apparatus and method of effectively training an animal utilizing positive reinforcement techniques which is relatively effective and simple for the animal as well as the trainer.

### BRIEF DESCRIPTION OF THE FIGURES

FIG. 1A illustrates a perspective view of the training system in accordance with one embodiment of the present invention.

FIG. 1B illustrates a perspective view of the training system in accordance with one embodiment of the present invention.

FIG. 2A illustrates a view of the container of the training dispenser in accordance with one embodiment of the present invention.

FIG. 2B illustrates a view of the disk dispensing mechanism of the training dispenser in accordance with one embodiment of the present invention.

FIG. 3 illustrates a schematic of the training dispenser in accordance with one embodiment of the present invention.

FIG. 4A illustrates a schematic of a training wand in accordance with one embodiment of the present invention.

FIG. 4B illustrates a schematic of a remote control with training wand retracted in accordance with one embodiment of the present invention.

FIG. 4C illustrates a schematic of the remote control with training wand extended in accordance with one embodiment of the present invention.

FIG. 4D illustrates a side view of a freestanding training wand in accordance with one embodiment of the present invention.

FIG. 5 illustrates a perspective view of an alternative training system in accordance with another embodiment of the present invention.

FIG. 6 illustrates a schematic of the training dispenser with sensing pad in accordance with one embodiment of the present invention.

FIG. 7 illustrates a perspective view of the training dispenser with an additional food container attached thereto in accordance with one embodiment of the present invention.

FIG. 8 illustrates a perspective view of the training dispenser with a trough attachment in accordance with one embodiment of the present invention.

### DETAILED DESCRIPTION OF THE PRESENT INVENTION

Embodiments of the present invention are directed to an apparatus and method of effectively training an animal utilizing positive reinforcement techniques. The present invention is directed to a dispensing apparatus which is used in conjunction with a novel training process, whereby the trainer utilizes the dispensing apparatus to timely dispense food pellets when the animal executes a command or complies with an expected behavior. The timing at which the apparatus dispenses food pellets, in conjunction with executed command or behavior compliance trains the animal that more of the same is expected and will be rewarded.

The present invention preferably includes a remote control device which controls the dispensing device, whereby the trainer is able to easily positively reinforce the animal's behavior from a distance. The present invention also preferably includes a wand used for target training. The device is also preferably configured to automatically dispense food pellets when sensing that the animal is in the down position. The device includes an automatic dispensing mode as well as manual dispensing mode. In the automatic dispensing mode, the device dispenses food pellets at a desired fixed rate or a variable rate.

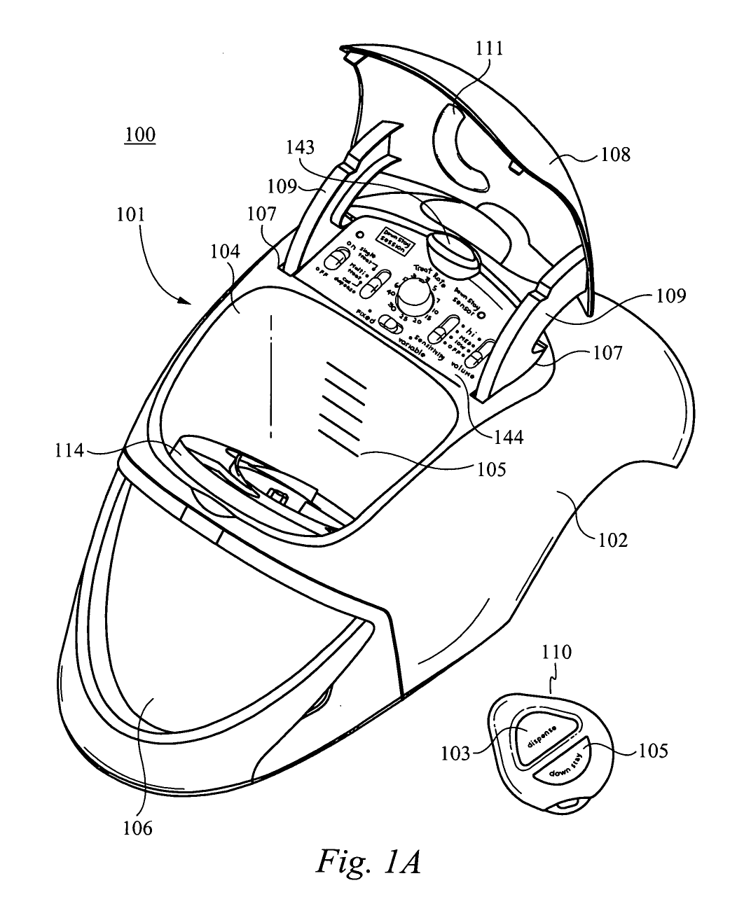

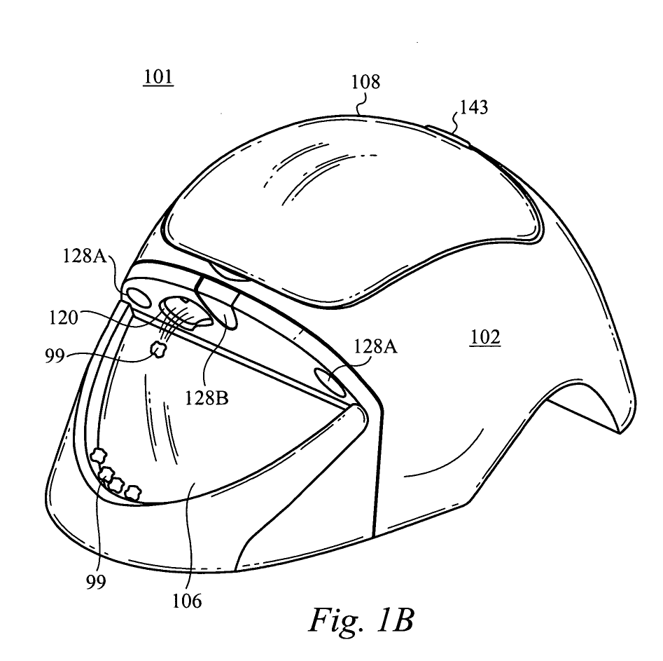

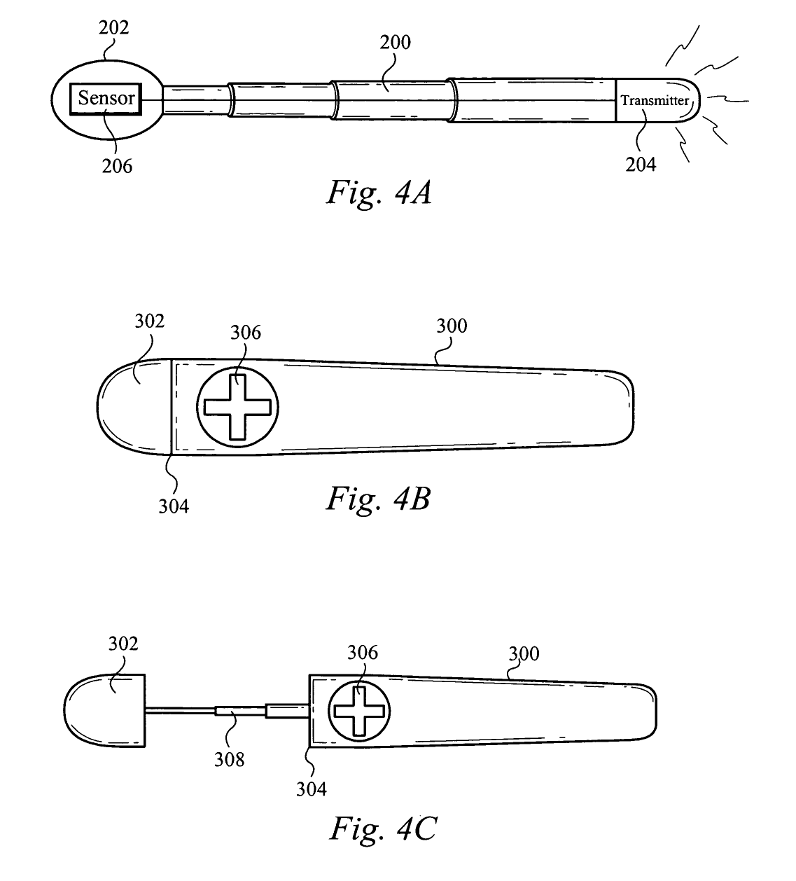

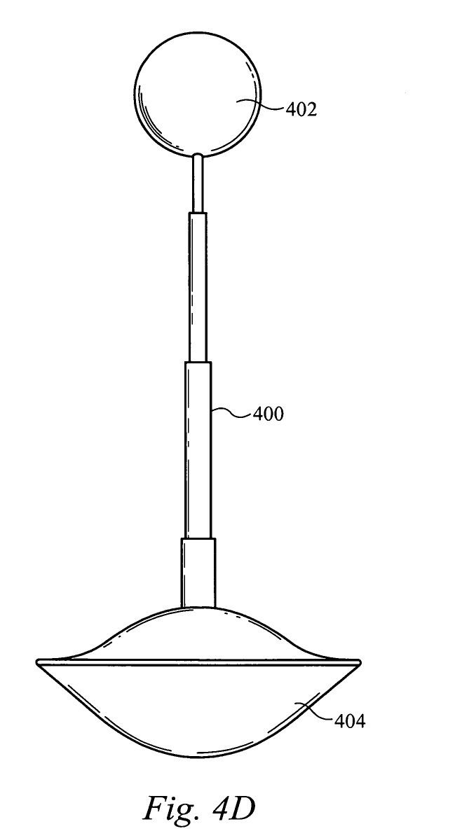

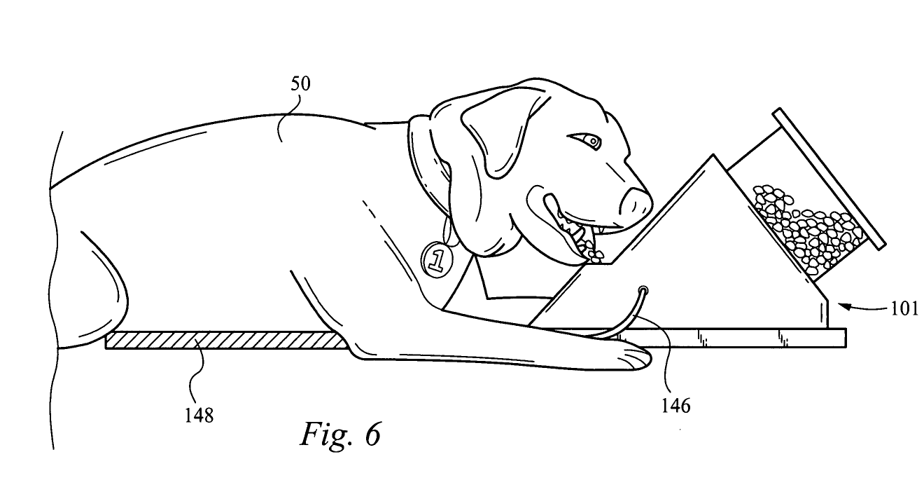

FIG. 1A illustrates a perspective view of the training system in accordance with one embodiment of the present invention. The system 100 preferably includes a dispensing device 101 and a remote control device 110. It is preferred that the remote control device 110 wirelessly transmits signals to the dispensing device 101. Alternatively, the remote control device 110 is coupled to the dispensing device 101 by a wire, whereby the remote control 110 transmits signals to the dispensing device 101 via the wire. The system 100 also preferably includes a training wand 140 (FIGS. 4A-4D) used in target training. Target training is an exercise where the animal is trained to touch a moving or stationary target on command as discussed in more detail below. It should be noted that the system 100 alternatively includes additional devices which are used to train the animal in conjunction with the present protocol. Such devices include, but are not limited to, pet toys and other objects such as targets that communicate the actions of the animal to the system 100. The system 100 is preferably utilized to train dogs 50 (FIG. 6), although the system 100 can be used to train any other type of animal. The configuration of the device 101 shown and described is preferred and is not limited to the configuration shown.

As shown in FIG. 1A, the dispensing device 101 preferably has a stable body 102 which has a food container 104 within. The body 102 is preferably able to stand on a hard or carpeted floor without able to be knocked over by the animal. The device 101 preferably includes a food container 104 within the body 102, a trough receptacle 106 removably coupled to the body 102, a light 143, a control panel 144, and a lid 108. The device 101 is preferably utilized for residential animal training. However, the device 101 can also be utilized in a commercial or veterinary setting (e.g. kennel). It should be noted that the shape and configuration of the device 101 body shown in the Figures is preferred, but any other appropriate design is contemplated. For example, the device 101 can alternatively have a rectangular, square or other shape. In one embodiment, the device 101 can have a shape of an animal, such as a dog.

As shown in FIG. 1A, the system 100 utilizes a remote control 110 to operate the dispensing device 101 from a distance. As stated above, the remote control 110 transmits a dispensing signal to the device 101, whereby the device 101 dispenses a food pellet 99 (FIG. 1B) upon receiving the signal. In particular, to dispense a food pellet 99, the dispense button 102 is preferably depressed. Preferably, the user is able to hold the dispense button 102 pressed down to continuously dispense rounds of food 99 from the device 101. In particular, the device 101 receives a continuous dispense signal from the remote control 110, whereby the device 101 will automatically dispense a certain amount of food pellets 99. The remote control 110 is also preferably able to wirelessly transmit a Down-Stay signal to the device 101 by pressing the Down-Stay button 104. Upon receiving the Down-Stay signal, the device 101 will enter the Down-Stay mode. Alternatively, the remote control 110 includes more or less than two buttons. In addition, the remote control 110 is capable of remotely operating more or less features in the device 101. For example only, the remote control can include additional buttons including, but not limited to, an automatic/manual mode button, a dispensing rate button, a manual dispense button, and an On/Off button. The remote control 110 preferably operates on a DC battery source (not shown) and includes a transmitter which preferably transmits infrared signals to the device 101. Alternatively, the transmitter transmits signals using radio frequency (RF) signals or any other appropriate communication technique.

A rotatable dispensing disk 114 is located within the food container 104 as shown in FIG. 1A. The disk 114 selectively dispenses food from the food container 104 into a removable trough 106 through the chute 120 (FIG. 1B), whereby the animal retrieves dispensed food from the trough 106. In one embodiment, the food container 104 includes a series of food measuring marks 105 which aid the trainer in supplying an adequate amount of food 99 into the container 104.

A lid 108 is coupled to the body 102 and is pivotably movable between an open position, as in FIG. 1A, and a closed position, as in FIG. 1B. The lid 108 is preferably made of a transparent, translucent or opaque plastic material, although any other appropriate material is contemplated. The lid 108 is coupled to the body 102 by a pair of posts 109 which fit within a pair of corresponding slots 107 in the body 102. The posts 109 preferably have width and thickness dimensions slightly smaller than the width and thickness of the slots 107. Thus, the lid 108 is preferably able to be opened and closed without allowing food and other particles from entering through the slots 107 into the device 101 and interfering with the components within. Although the lid 108 shown in FIGS. 1A and 1B allows access to the container 104 and control panel 144 when opened, the lid 108 can have two individual lids configured to separately allow access to the container 104 and the control panel 144. This allows the trainer to have access to the control panel without exposing the food to the animal at the same time. In one embodiment, the lid 108 is removable from the device 101, although not necessary. In yet another embodiment, the lid 108 includes a handle 111 on the underside (i.e. side which faces the container 104), whereby the underside of the removed lid 108 can be used to scoop food from a food bag into the container 104.

FIG. 1B illustrates a perspective view of the device 101 with the lid 108 in the closed position. The device 101 preferably includes a sensing mechanism which includes one or more transmitting sensors 128A and one or more receiving sensors 128B. The sensing mechanism of the device 101 senses whether the animal is in front of the device 101, as will be discussed below. In the embodiment shown in FIG. 1B, the device 101 includes two transmitters 128A and one receiving sensor 128B. Alternatively, any number of transmitters and receiving sensors, including only one, is contemplated. The transmitters 128A preferably transmit an infrared signal toward a desired location in front of the device 101. Alternatively, the device 101 utilizes ultrasound, optical, radio-frequency or any other appropriate type of signal scheme. The desired location is preferably the location where the animal would be laying in front of the device 101 during the down-stay portion of the present protocol, discussed below. Upon the infrared signal hitting the animal, the signal is preferably bounced back toward the device 101 wherein the receiving sensor 128B receives the signal.

It should be noted that the sensing mechanism shown in FIG. 1B is only one example, and the device 101 alternatively utilizes any other appropriate sensing mechanism. For example, the system 100 can include a heat or pressure sensitive mat 148, as shown in FIG. 6. The mat 148 would be configured to signal to the device 101 that the animal is sitting in front of the device 101 at the desired location. The mat 148 is coupled to an input port 146 of the device 101 by a wire. Alternatively, a remote heat and/or pressure sensing sensor (not shown) is coupled to the device 101 which can be placed under an existing rug or the like which performs the same functions as the heat and/or pressure sensitive mat 148.

In another embodiment, the device can identify the animal utilizing any of a variety of methods, including but not limited to, utilizing a programmed transceiver collar, a RFID chip embedded in the animal, or the like. It is contemplated that the device 101 use the identifying technology discussed above to only dispense food pellets to the identified animals to prevent wild non-authorized animals from activating the device 101. In another embodiment, the device 101 does not utilize a sensing mechanism.

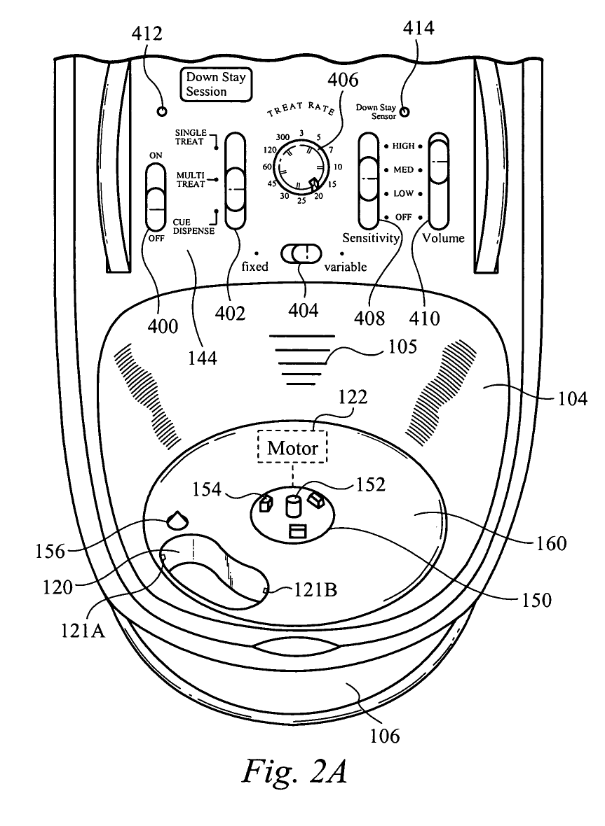

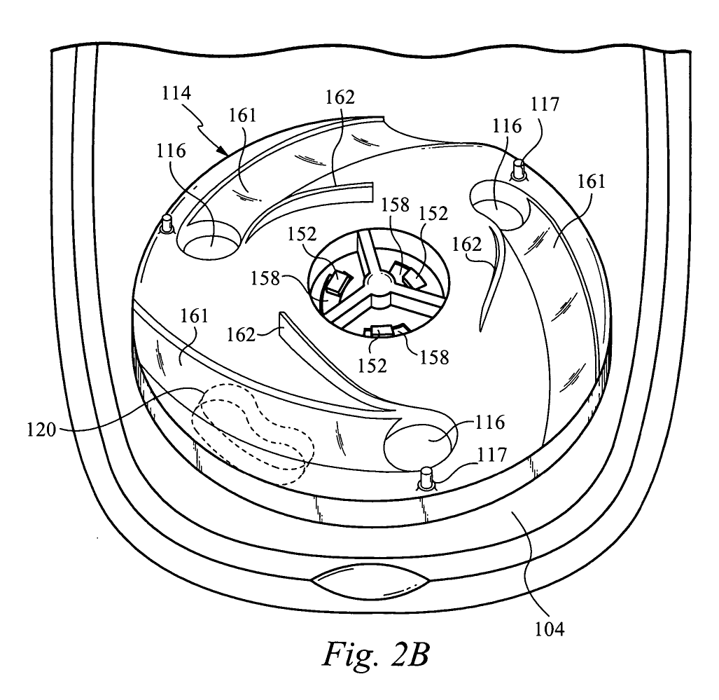

FIG. 2A illustrates a schematic of the training dispenser device 101 in accordance with one embodiment of the present invention. The food container 104 has a seating area 160 upon which the dispenser disk 114 sits. In particular, the seating area 160 includes a rotatable interface 150 which is attached to a motor 122 within the device 101. In operation, the motor 122 causes the interface 150 to rotate. In one embodiment, the interface 150 includes a series of protrusions 154 which engage the dispensing disk 114 (FIG. 2B) when the disk 114 is coupled to the device 101. The motor 122 thereby causes the received dispensing disk 114 to rotate about the pin 152 in either a clockwise or counterclockwise direction to selectively dispense food pellets 99 from the device 101.

In one embodiment, shown in FIG. 2A, the device 101 includes a food ejector protrusion 156 located in the seating area 160. The food ejector 156 serves to eject food pellets, which become stuck in the aperture 116, back into the container 104. In one embodiment, the food ejector 156 is a slight protrusion in the seating area 160. In another embodiment, the food ejector 156 is spring loaded, whereby the ejector 156 springs upward each time an aperture 116 of the disk 114 moves over the ejector 156. In another embodiment, the device 101 does not utilize a food ejector 156.

In one embodiment, the device 101 includes a chute 120 positioned between the container 104 and the trough 106 as shown in FIG. 2A, whereby food pellets 99 dispensed through the rotating disk 114 preferably travels down the chute 120 from the food container 104 to the trough 106, as shown in FIG. 1B. The opening to the chute 120 is preferably located near the top of the seating area 160, as shown in FIG. 2B. Alternatively, the opening of the chute 120 is located elsewhere in the seating area 160. The chute 120 preferably includes one or more sensors 121A, 121B which sense when a food pellet 99 pass through the chute 120 from the dispensing disk 114 to the trough 106. In one embodiment, one sensor 121A (e.g. LED) in the inner wall of the chute 120 continually or periodically transmits an infrared signal to a receiving sensor 121B on another inner wall of the chute 120, whereby the signal is bounced back toward the sensor 121A. The infrared signal is interrupted upon the food pellet 99 passing through the chute 120. In another embodiment, any number of sensors 121, including only one, are contemplated within or adjacent to the chute 120. In another embodiment, the device 101 includes any other appropriate sensor to sense that the food pellet 99 is adequately dropped into the trough 106. It is contemplated that the sensors 121A, 121B are alternatively, or additionally, located anywhere in the container 104, the trough 106 and/or the disk 114 within the scope of the present invention. In yet another embodiment, the device 101 does not include dispensing sensors 121.

FIG. 2B illustrates a view of the container 104 of the dispenser device 101 in accordance with one embodiment of the present invention. As shown in FIG. 2B, the dispensing disk 114 is attached to the rotatable interface 150 in the seating area 160. In particular, the disk 114 preferably includes a series of slots 158 disposed about its center which receive and engage the interface protrusions 152, as shown in FIG. 2B. To attach the disk 114 to the rotatable interface 150 (FIG. 2A), the slots 158 near the center of the disk 114 are aligned with the engaging protrusions 152, whereby the protrusions 152 fit within the slots 158. The disk 114 is then preferably twisted about its center to lock the disk 114 into place. The disk 114 is also preferably removable from the seating area to allow the disk 114 as well as the seating area 160 to be cleaned. Removal of the disk 114 is preferably performed by twisting the disk 114 in the opposite direction about its center. In addition, the disk 114 is removable to allow the user to replace the disk 114 with another disk 114 having apertures of a different size. Thus, the user is able to use the device 101 to dispense different sized food pellets. The replaceable disks 114 allow the user to use the device with more than one animal or to accommodate the animal as the animal gets older and requires larger sized food pellets 99. Alternatively, one disk 114 is utilized without the need of replacing the disk 114, whereby either the disk apertures 116 or chute opening 120 is adjustable in dimension to accommodate different sized pellets 99. The disk 114 coupled to the seating area 160 in any alternative manner. In another embodiment, the device 101 does not include a rotating disk 114, but any other appropriate dispensing mechanism which allows food pellets 99 to be delivered from the container 104 to the trough 106.

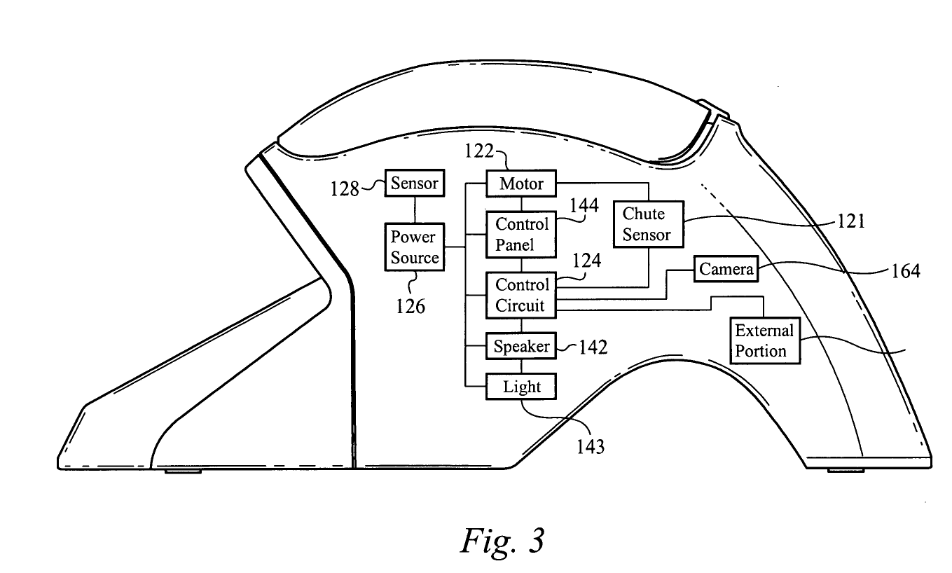

The disk 114 is preferably circular, as shown in FIG. 2B and includes one or more apertures 116 which are radially disposed about the center of the disk 114. The rotating disk 114 preferably includes three apertures 116 equidistantly spaced, as shown in FIG. 2B. Alternatively, the apertures 116 are alternatively spaced at any other distance from one another. Although the apertures 116 are shown as circular in shape in FIG. 3, it is apparent to one skilled in the art that slots or other shaped apertures 116 are contemplated. Each aperture 116 catches one or more food pellets 99 from the container 104 as the disk 114 rotates. In the preferred embodiment, once the pellet 99 is caught in the aperture 116, the disk 114 rotates and carries the pellet 99 toward the chute 120, shown in dashed lines. Additionally, as the aperture 116, having the food pellet 99 within, approaches the chute, the aperture 116 of the disk 114 picks up another food pellet 99 from the food container 104. Thus, the disk 114 automatically and continually picks up and carries food pellets 99 from the food container 104. The disk 114 carries the food pellet 99 until the aperture 116 is aligned with the chute opening 120, whereby the food pellet 99 drops, from gravity, into the chute 120. It is preferred that once the food pellet 99 drops into the chute 120, the disk 114 continues to rotate until the next aperture 116 to pass over the chute 120 is positioned adjacent to the chute 120. This allows the device 101 to almost immediately dispense the next food pellet 99 when instructed to dispense. In addition, the position of the aperture 116 adjacent to the chute 120 causes the disk 114 to block any entry into the container 104 from the trough 106 via the chute 120. This prevents the animal from having access to the container 104 when the device 101 is not dispensing food pellets 99, is awaiting instructions, or is shut off. The disk 114 is able to rotate to its desired position preferably by an optical encoder within the device which reads the position of the disk 114 as the disk 114 rotates. In another embodiment, the device utilizes a step-motor which controls the rotation of the disk 114 and monitors the position of the disk 114. It is apparent that any other appropriate means for controlling the rotation and the position of the disk 114 is contemplated for use in the present invention.

Once the sensor 121A senses the food pellet 99 successfully passing into the receptacle 106, a dispensed signal is sent to the control circuit 124. Depending on the selected mode of operation of the device 101, the disk 114 will then stop rotating. Alternatively, depending on the mode of operation of the device 101, the disk 114 will continue to rotate and dispense more food pellets 99. It should be noted that the position of the disk 114 is controlled by either the motor 122 itself or by the optical encoder discussed above. In the case that the sensors 121A, 121B do not sense that a food pellet 99 has dropped through the chute, the disk 114 will continue to rotate to deliver another food pellet 99. The control circuit 124 monitors the number of complete rotations of the disk 114 and will only allow the disk 112 to rotate for a predetermined number of times (e.g. five complete rotations) without delivering food pellets 99 to the chute 120 before stopping. The device 101 will preferably also provide an error message, in the form of a sound, light or other indicator, that the device 101 is unable to dispense food pellets. This feature notifies the user that the device 101 is not working properly or is out of food pellets.

The disk 114 is preferably made of plastic, although any other appropriate material is contemplated. The disk 114 preferably includes a recessed portion 161 which extends from each aperture 116 toward the outer edge of the disk 114, as shown in FIG. 2B. The recessed portions 161 aid in retrieving or shoveling food pellets 99 from the container 104 and guiding the retrieved food pellets 99 into the apertures 116 as the disk 114 rotates. The disk 114 is thereby able to efficiently gather food pellets 99 from the container and minimize missed placement of the food pellets 99 in the apertures 116. Additionally, the disk 114 preferably includes one or more fins 162 which protrude from the top side of the disk 114, whereby the fins 162 act to continually agitate the placement of the food pellets 99 in the container 104 while the disk 114 rotates. The fins 162 thereby prevent food pellets 99 from becoming stuck and also help in guiding food pellets 99 toward the apertures 116.

In one embodiment, the disk 114 includes one or more protrusions 117 that are disposed near the outer edge of the disk 114. The protrusions 117 agitates the food pellets 99 in the food container 104 and help to guide the food pellets 99 into the apertures 116. The protrusions 117 are shown disposed between the apertures 116 and the outer edge of the disk 114, although the protrusions 117 can be disposed elsewhere on the disk 114. Although the protrusions 117 are shown having a cylindrical shape, the protrusions 117 alternatively have any other appropriate shape. In another embodiment, the disk 114 does not include the protrusions 117 thereon.

FIG. 3 illustrates a schematic of the device 101 in accordance with the present invention. As stated above, the device 101 preferably includes the receiving sensor 128, the control circuit 124, the motor 126, a speaker 142, one or more lights 143, the control panel 144, the chute sensor 121 and a power source 126. The receiving sensor 128 and speaker 142 are coupled to the control circuit 124. In addition, the control panel 124 and motor 126 are coupled to the control circuit 124. The control circuit 124, motor 126, speaker 142, and control panel 144 are coupled to the power source 126. The chute sensor 121 is coupled to the control circuit 124 as well as the motor 122. It should be noted that additional components are contemplated for use with the present invention, some of which are discussed below. Alternatively, less components than those shown and described in relation to FIG. 3 are contemplated for use with the present invention. For example, the device 101 alternatively does not utilize a chute sensor 121 and/or light 143. It is also contemplated that different components than those shown and described in FIG. 3 are contemplated for use with the present invention. In another embodiment, the device 101 includes a microphone, whereby the trainer is able to instruct the device 101 to dispense food pellets 99 using voice commands. Alternatively or additionally, the device 101 can utilize the microphone to sense animal sounds, whereby the device 101 will not dispense food pellets 99 upon sensing the animal barking or whining.

In one embodiment of the present invention, the device 101 dispenses food pellets 99 upon the sensor 128 wirelessly receiving an appropriate signal from the remote control 110 shown in FIG. 1A. Alternatively, or in addition to, the device 101 dispenses food pellets 99 upon the sensor 128 wirelessly receiving an appropriate signal from a target wand 140 (FIG. 4A). In particular, the receiving sensor 128, upon receiving the transmitted signal, sends a signal to the control circuit 124. The control circuit 124 then activates the motor 122 to dispense the food pellets and simultaneously activates the speaker 142 to notify the animal that food pellets 99 are being dispensed. Alternatively, or in addition to, the control circuit 124 causes the device 101 to automatically dispense one or more food pellets 99 upon the sensor 128 sensing the animal lying down substantially in front of the device 101, as discussed below. The device 101 is operated by the power source 126 which is preferably a DC battery power source. Alternatively, or in addition to, the power source 126 is an AC power source.

The speaker 142 is configured to emit a distinct sound when the device 101 is activated and the food pellet 99 is dispensed from the container 104. The distinct sound made by the speaker 132 preferably attracts the animal's attention such that the animal knows that a food pellet 99 is being dispensed by the device 101. A typical sound emitting device or piezoelectric device is utilized as the speaker 142. In one embodiment, the speaker 142 emits a sound within the frequency range audible to the human ear. Alternatively, or in addition to, the speaker 142 emits a sound within the frequency range audible to only the animal. The device 101 preferably includes a volume control 410 (FIG. 2A) which allows the user to set the volume range of the speaker 128. In one embodiment, the volume control 410 (FIG. 2A) is an individual control switch located on the control panel 144, although the volume control 410 is alternatively located elsewhere on the device 101 and/or the remote control 110. The speaker 142 is preferably capable of emitting multi-frequency tones as well as single frequency tones. The speaker 142 is also preferably capable of emitting monophonic as well as polyphonic tones. In one embodiment, the device 101 includes a plurality of stored tones and/or sounds that are either pre-stored or are recordable by the user. The user is able to select one or more of the stored tones and/or sounds which are then emitted by the speaker 142 when the device 101 is activated. In another embodiment, the remote control 110 includes a speaker which emits a tone upon receiving an appropriate signal from the device 101. For example, the speaker on the remote control 110 can be used to emit a tone, whereby the animal is taught to run to the remote control 110 to press the dispensing button 102 upon hearing the tone emitted from the remote control 110.

The light 143 on the device 101 is preferably utilized to notify the trainer that the device is in the Down-Stay mode, discussed below. The light 143 on the device 101 can be alternatively utilized to notify the trainer when to dispense the food pellets 99 from the device 101 in the Cue-Dispense mode. Alternatively, the light 143 is substituted for the speaker 142 in notifying the animal that one or more food pellets 99 are being dispensed by the device 101. This is particularly useful in utilizing the device 101 to train deaf or hearing impaired animals. In one embodiment, the light 143 comes on and remains on for a predetermined amount of time. In another embodiment, the light 143 periodically flashes to notify the trainer or animal that the food pellet 99 has been dispensed.

In one embodiment, the device 101 includes a sleep timer feature, whereby the device 101 will go into sleep or time-out mode after an amount of inactivity (e.g. 30 minutes). In one embodiment, the sensor 128B intermittently checks for a dispensing signal from the remote control 110 or the wand 140 (e.g. every 5 seconds). In the embodiment, the device 101 is able to be activated by pressing and holding down the dispensing button 102 on the remote control 110 or sensor 204 on the wand 140 for a certain amount of time (e.g. 5 seconds). Once the sensor 128B receives the signal while performing the signal check function, the device 101 becomes activated. The desired amount of time is set by the manufacturer or variably set by the user, either directly into the device 101 or by the remote control 110.

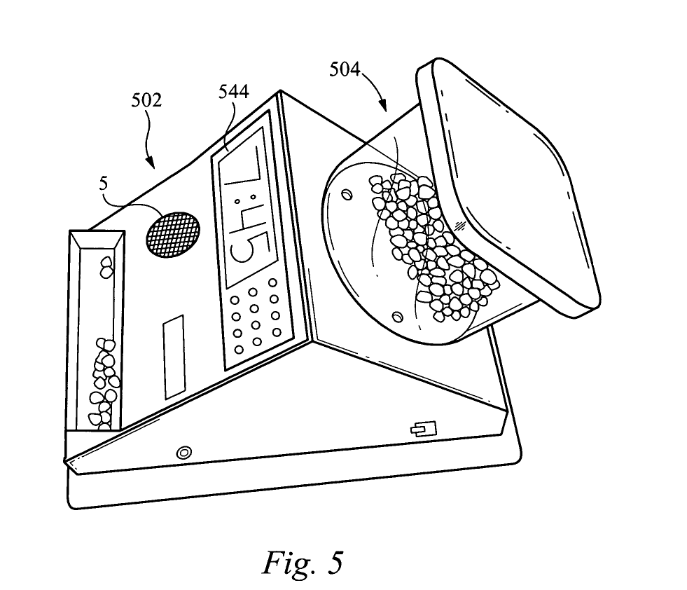

Referring back to FIG. 2A, the control panel 144 preferably includes an On/Off Switch 400 and corresponding indicator 412, a down-stay session selector 402, a fixed or variable dispenser selector 404, a Treat Rate adjuster or dial 406, a sensor sensitivity selector 408 and corresponding indicator 414, and a volume control 410. It is contemplated that the control panel 144 alternatively includes additional or fewer controls. The control panel 144 alternatively includes a liquid crystal digital display, as shown in FIG. 5. Alternatively, the control panel 144 has any other configuration and/or other controls and is not limited to what is described herein.

The device 101 is preferably capable of dispensing food pellets in an automatic mode as well as in a manual mode. In the manual mode, the device 101 dispenses food pellets 99 upon receiving a dispense signal from the remote control 110, wand 140, or other appropriate device. It is preferred that the device 101 is always in manual mode and does not have a separate switch to activate the device 101 between the manual and automatic modes. It is preferred that the device 100 will nonetheless dispense food pellets 99 upon receiving the dispense signal irrespective of what setting the Down-Stay selector 402 is selected to. The down-stay session is started by pressing the “Downstay” button on the remote control.

The Down-Stay Selector 402 preferably sets the device 101 to a desired automatic mode. As shown in FIG. 2A, the device 101 is able to operate in the automatic mode under three settings: Single-Treat, Multi-Treat, and Cue-Dispense. When in the Single-Treat setting, the device 101 automatically dispenses one pellet of food 99 at the dispensing rate selected by the user using the Treat Rate dial 406 (e.g. every three seconds). In the Multi-Treat setting, the device 101 automatically dispenses multiple pellets of food 99 at the dispensing rate selected by the user using the treat rate dial 406. The Multi-Treat setting allows the device 101 to train larger animals which require more pellets of food 99 per exercise than a smaller animal. In one embodiment, the trainer is able to set how many pellets of food 99 are dispensed by the device 101 in the Multi-Treat setting. In another embodiment, the number of food pellets 99 dispensed is set by the manufacturer.

Additionally, the Down-Stay selector 402 is able to be set to the Cue-Dispense setting. In the Cue-Dispense setting, the device 101 does not automatically dispense a food pellet 99, but instead preferably emits a cue tone after a set amount of time for the trainer to press the dispense button 102 on the remote control to dispense a food pellet 99. The Cue-Dispense setting is used when the animal is not consistently following instructions from the trainer, thereby affording the user the control to dispense a food pellet 99 only when the animal is following instructions from the trainer. The cue tone preferably has a lower or different tone than the dispensing tone so that the animal does not confuse the cue tone and the dispense tone. In one embodiment, the light 143 also operates in the Cue-Dispense setting, whereby the light 143 turns on when the device 101 is in the cue-dispense mode. In another embodiment, the light 143 remains on and then shuts off when the device 101 emits the cue tone. In yet another embodiment, the light 143 does not operate in the Cue-Dispense setting. Once the Down-Stay selector is set at Cue-Dispense, the device 101 and light 143 are preferably able to be activated by depressing the Down-Stay button 104 on the remote control 110 (FIG. 1A).

Regarding the Treat Rate dial 406, the user is preferably able to set the desired dispensing rate of the device 101. This can be done either directly into the control panel 144 of the device 101 and/or using the remote control 110. In another embodiment, the user sets the desired dispensing rate using any other appropriate mechanism or method. The rate at which the food pellet 99 is selected to be dispensed is controlled by the control circuit 124. Thus, if the user sets the device 101 to dispense every three seconds, the control circuit 124 will activate the motor and speaker 142 every three seconds. In another embodiment, the control circuit 124 increases and decreases the rate of rotation of the rotating disk 114 such that the food pellet is dispensed at the desired rate. It is preferred that the dispensing rate is able to be set to three, five, seven, ten, fifteen, twenty, twenty-five, thirty, forty-five and sixty seconds, as shown in FIG. 2A. Additionally, the Treat Rate dial 406 is preferably able to set to 2 minutes (120 seconds) as well as 5 minutes (300 seconds). Alternatively, the dial 406 is able to be set to any other amount of time.

Additionally, the control panel 144 preferably also includes a Fixed/Variable rate selector 404, whereby the device 101 dispenses food pellets 99 in a fixed or variable manner when operating in the automatic mode. The Fixed/Variable rate selector 404 operates in conjunction with the Treat Rate dial 406 to adjust the rate at which pellets 99 are dispensed. When set to the Fixed Rate setting, the device 101 automatically dispenses a food pellet 99 depending on the dispensing rate at which the dial 406 is set (e.g. 5 seconds). When in the Variable Rate setting, the device 101 dispenses food pellets 99 randomly, whereby the average dispensing rate is approximate to the time setting at which the dial 406 is set. For example, the user can set the Treat Rate dial 406 to 10 seconds, whereby the device 101 will randomly dispense food pellets 99 automatically, whereby the average dispensing rate will be 10 seconds. In another embodiment, the device 101 will dispense food pellets 99 completely randomly. Although the user is able to access the Variable Rate selector 404 directly on the device 101, the selector 404 can alternatively or additionally be located on the remote control 110.

The variable or random timing of the dispensing device 101 is preferably controlled by the control circuit 124, whereby control circuit 124 randomly selects a time interval which is consistent with the overall average dispensing rate set by the Treat Rate dial 406 and activates the motor 122 to rotate the disk 412 once the time interval has been counted by an internal timer (not shown). In another embodiment, the rotating disk 114 rotates at a varying speed to maintain the average of the rate at which the Treat Rate dial 406 is set. In another embodiment, the device 101 does not utilize the rotating disk 412, whereby the control circuit 124 activates the alternative dispensing mechanism.

Additionally, as shown in FIG. 2A, the control panel 144 includes a Sensor Sensitivity control 408 as well as a Sensor indicator 414. The Sensor Sensitivity control 408 is coupled to the control circuit 124 and is operatively connected to the sensors 128A, 128B. In particular, the sensor control 408 is able to be set in the Off, Low, Med and High settings. The control 408 sets the sensitivity of the sensors 128A, 128B such that the sensors 128A, 128B are able to detect that the animal. Preferably the indicator light 414 illuminates when the sensors 128A, 128B detect the animal in the Down-Stay position in front of the device 101. It is preferred that the High setting is for animals which are relatively small, whereas the Low setting is for animals which are larger. When the control 408 is placed in the Off setting, the sensors 128A, 128B do not operate. The Down-Stay indicator 414 preferably lights up when the sensors 128A, 128B detect that the animal is sitting in front of the device 101. The specific applications of the Down-Stay Sensors are discussed below.

FIG. 4A illustrates a view of a target wand 200 in accordance with one embodiment of the present invention. The wand 200 preferably includes a handle having a touch end 202 which the animal touches with its nose. The wand 200 is utilized to train the animal during the target training exercise of the present training protocol. In one embodiment, the wand 200 automatically causes the device 101 to dispense a food pellet 99 when the animal touches the touch end or “target” 202 of the wand 200. This is accomplished as the wand 200 and/or the remote control 110 is able to automatically send a signal to the device 101 when the animal touches the target 202. The wand 200 is of sufficient length such that the user is able to keep the animal at a distance from the trainer and the device 101. In one embodiment, the handle of the wand 200 is retractable for easy storage and adjustable for animals and people of different heights, as shown in FIG. 4A. Alternatively, the wand 200 has a fixed length. In another embodiment, the wand 200 includes a stand or other device on the end opposite of the touch end 202, as shown in FIG. 4D, to allow the wand 200 to be able to be propped upward as a freestanding target. Preferably, the stand has a self-righting base which causes the target to stand upright.

In one embodiment, as shown in FIG. 4A, the wand 200 includes a sensor 206 within the touch end 202, a transmitter 204 coupled to the sensor 206 as well as a power supply (not shown) coupled to the transmitter 204 and the sensor 206. The sensor 206 in the wand 200 senses when the animal touches the touch end 202 in which the transmitter 204 will automatically transmit a dispensing signal to the device 101. The transmitter 204 utilizes infrared, RF or any other appropriate communication technique to transmit the dispensing signal to the device 101. Alternatively, the transmitter 204 transmits the dispensing signal to the device 101 by a wire. In another embodiment, the wand 200 does not include a sensor 206 nor a transmitter 204, whereby the user holds the remote control 110 and manually activates the device 101 when the animal touches the touch end 202.

In another embodiment, the remote control 300 and wand 308 are incorporated into one device, as shown in FIGS. 4B and 4C. Although the wand 308 is shown on the end of the remote control closest to the buttons 306 in FIGS. 4B and 4C, the wand 308 is alternatively located on the end of the remote control furthest from the buttons 306. The wand 308 is preferably retractable, as shown in FIG. 4B, for situations when the user is not engaging the animal in the target training procedure. Alternatively, the wand 308 coupled to the remote control 300 is not retractable. As discussed above in relation to FIG. 4A, the touch end 302 of the wand 308 automatically transmits a dispensing signal to the device 101 via the transmitter 304 of the remote control 300 when the animal touches the touch end 302. Alternatively, the user manually activates the device 101 by pressing the dispensing button on the remote control 300 when the animal touches the touch end 302 on the remote control 300. When the wand 308 is either in the extended or retracted position, the remote control 304 is preferably able to transmit signals to the device 101 via the transmitter 304.

FIG. 5 illustrates another embodiment of the dispenser in accordance with the present invention. The device 502 includes an external food container 504 which has a substantially cylindrical shape with an opening on each end. The cylindrical shape of the container 104 is preferably circular, although any other shape is contemplated. One open end of the container 104 is coupled to the body 102, whereas the other open end allows the user to place food pellets into the container 104. The container 106 can be removable from the body 102 for cleaning purposes. In addition, the device 502 includes a control panel 506 which performs some or all of the functions in the control panel 144 discussed above.

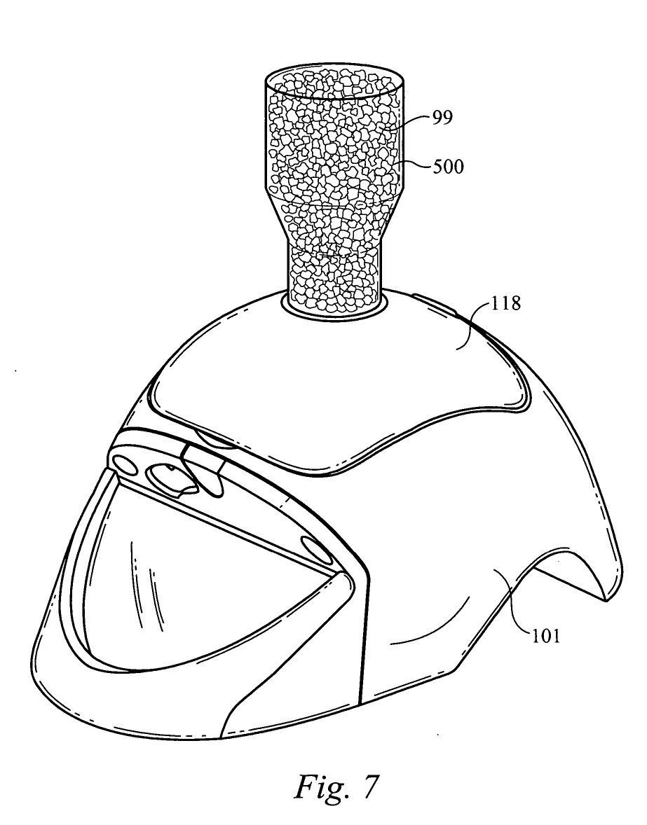

FIG. 7 illustrates a perspective view of the training dispenser with an additional food container attached thereto. In the embodiment shown in FIG. 7, the device 101 includes the external food container attachment 500 which is removably coupled to the device 101. The attachment 500 holds additional food pellets 99, so that the device 101 can serve as an animal feeding bowl while the animal is left while on vacation. In one embodiment, as shown in FIG. 7, the attachment 500 is coupled to the top of the lid 108, wherein the lid 108 has a separate opening which accepts and engages the bottom of the container attachment 500. The attachment 500 is preferably designed to continually dispense food pellets 99 by gravity into the container 104 as the food level within the container 104 decreases. In another embodiment, the container attachment 500 is attached to the side or back of the device 101 in which an additional chute allows food pellets 99 from the external attachment to be dispensed to the food container 104. In one embodiment, the container attachment 500 is refillable with animal food pellets 99. In another embodiment, the container attachment 500 is disposable.

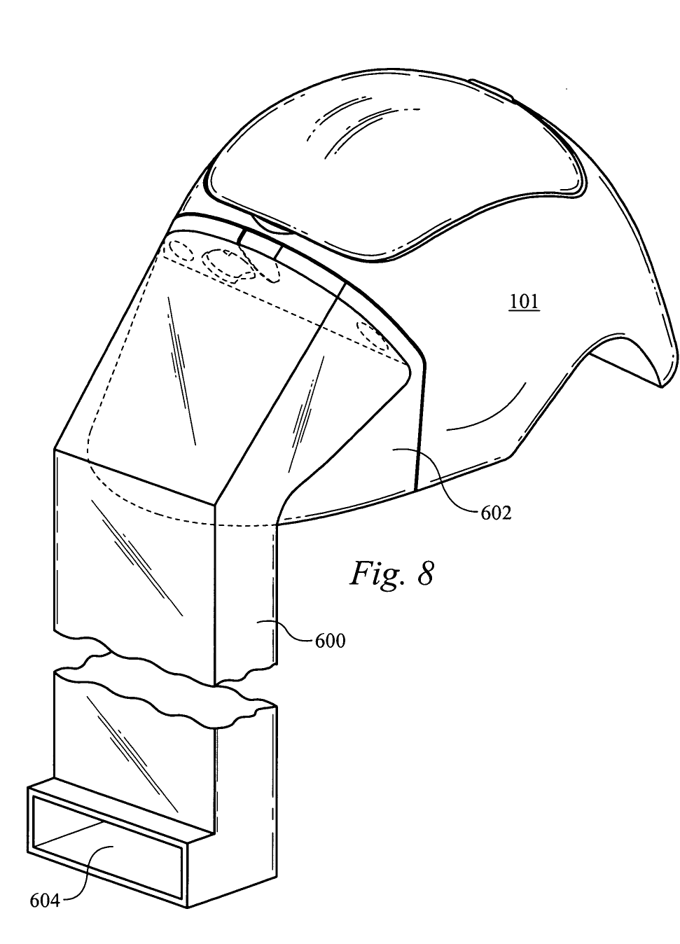

FIG. 8 illustrates a perspective view of the training dispenser with a trough attachment. The trough extension 600 allows the device 101 to dispense food pellets 99 to the animal on or near the ground while being placed on an upper shelf or strapped to a wall, gate or other structure. As shown in FIG. 8, the trough extension 600 is coupled to the section of the device 101 where the trough 106 (FIGS. 1A-1B) attaches. In one embodiment, the trough 106 is removed to allow the trough extension 600 to be attached to the device 101. In another embodiment, the trough 160 remains attached to the device 101 while the trough extension 600 is attached. The trough extension 600 has a first end 602 which attaches to the device 101 and a second end 604 from which the animal retrieves the dispensed food pellet 99. The extension 600 can be used when the device 101 is used as a smart animal feeding bowl while the owner is away, whereby the actual device 101 is out of the reach of the animal. Alternatively, the extension 600 can be used when the device 101 is used in a kennel or veterinary office, wherein the device 101 is out of the reach of the animal and simply drops food pellets 99 into kennel crates.

The system 100 of the present invention can include additional or other features which expand the use of the present system 100. For instance, in one embodiment, the device 101 includes a communications port 166 (FIG. 3) which connects the device 101 to a network (e.g. World Wide Web, LAN) or computer and allows the user to control the device 101 remotely from a computer. The external communication port 166 can be a serial, USB, Bluetooth or WIFI port. Software on a client computer can be used to program and control the operations of the device (e.g. switch between Cue-Dispense and Single-Treat settings), turn On/Off the device, watch the animal through an internal or external camera 164 (FIG. 3) or perform any other function remotely. This feature allows the user to train/feed the animal by selectively controlling the device 101 while at work, on vacation or from another area within the house.

In another embodiment, the device 101 includes a memory coupled to the control circuit 124 in which the memory stores profile information pertaining to the settings at which the device 101 operates for the animal, the entire training protocol, and/or the progress of the particular animal in the stored training protocol. The trainer is able to conveniently retrieve the desired information from the memory by any appropriate means. For example, the trainer can retrieve the progress of the animal's training as well as the stored training protocol and continue with the training process at any time with a touch of a button on the device 101, remote control 110 or remote computer. In one embodiment, the memory is able to store profile information relating to more than one animal (e.g. in a kennel), whereby the trainer is able to conveniently reconfigure the device 101 to operate for any of the particular animals by retrieving the appropriate profile information. In one embodiment, the device 101 is able to automatically retrieve profile information by sensing and identifying the animal (see above).

The device 101 alternatively includes a transceiver which allows the device 101 to communicate and with one or more other training devices 101 located elsewhere (e.g. outside, another room, across the yard). The device 101 would be programmed to transmit a dispense signal to one or more of the other training devices 101. Upon the other device 101 receiving the dispense signal, the device 101 would emit the tone and dispense food pellets 99. Upon the animal hearing the tone, the animal would run from to the dispensing training device 101 to retrieve its food pellet. Upon the animal retrieving the food pellets 99 from the dispensing device 101, the dispensing device 101 would sense the presence of the animal using the sensors 128A, 128B and then transmit a dispense signal to another device 101. This process can then be repeated, whereby the animal would run to the next dispensing device 101 to retrieve the food pellets 99.

As stated above, the device 101 is preferably used in a residential or commercial setting, whereby the device 101 is a stand-alone unit which sits on a platform. In another embodiment, the device 101 is a small, portable unit which can be used in a vehicle. In another embodiment, the device 101 is configured to be attached to an animal transporter (e.g. for use in transporting the animal on a plane or automobile). In yet another embodiment, the device 101 is a small, personal device which fits in the trainer's hand and can be carried around in the user's pocket, whereby the device 101 would dispense food pellets into the trainer's hand in accordance with the present invention. Further, any other type of appropriate animal food besides pellets can be dispensed by the present device 100. In another embodiment, the present system 100 can be modified to dispense liquid (e.g. water) as well as food pellets 99 by utilizing the food dispensing mechanism, preferably including the rotatable dispensing disk 114, with a liquid dispensing valve. The controls of the present device in the liquid dispensing embodiment can be the same or different than what is described herein.

Operation of the dispensing system 100 along with the novel training protocol of the present device will now be discussed in accordance with one embodiment of the present invention. The training protocol of the present invention is preferably used in association with the device 101 as well as the remote control 110 and/or the target wand 202. As mentioned, the training protocol and system of the present invention is advantageous to the animal, because the animal is taught to execute commands and conform to the good behavior based on positive reinforcement techniques. In addition, the training protocol and system of the present invention is advantageous to the user, because the user is able to execute the training protocol easily and substantially without the aid of another person. The system 100 also allows the user to conduct the training session without the need of constantly stopping the training to reach down and feed the animal a food pellet. Therefore, the system 100 and corresponding training protocol allows the user to focus on training the animal instead of other factors. Although the preferred operation is discussed, it is apparent that variations and differences in the order of steps and training protocol itself as well as the operation of the device 101 in conjunction with the training protocol are contemplated.

In accordance with one embodiment of the present protocol, the user preferably sets up the device 101 by loading food pellets 99 into the container 104 and, if needed, adjusting the volume, tone, and/or frequency of the speaker to the desired settings, preferably when the animal is not in the room. The volume is preferably loud enough so that the sound emitted by the device 101, when activated, will attract the animal's attention and cause the animal to orient itself toward the device 101 without startling the animal. Once the settings are adjusted, the animal is preferably placed in view of the device 101 in accordance with one embodiment of the present protocol. In accordance with the present protocol, the user initially places a few pellets of the food 99 in the trough 106 to attract and introduce the animal to the device 101. The user then preferably adds more pellets 99 until the animal readily eats from the trough 106.

Once the animal is familiar with the device 101, the user establishes an association between the sound emitted and the food pellets dispensed by the device 101 in accordance with one embodiment of the present invention. The association established between the sound and the food pellet with the animal is utilized to train the animal using the present training protocol. With the animal oriented toward the device 101, the user operates the device 101, preferably by pressing the dispense button 102 on the remote control 110, whereby the device 101 emits a tone or sound and simultaneously releases a food pellet 99 into the trough 106. For purposes of the present description, it is contemplated that the device 101 simultaneously emits a tone and dispenses a food pellet 99 when activated. Alternatively, the device 101 either only emits a tone, emits a light, and/or only dispenses a food pellet 99.

Upon hearing the sound and seeing the food pellet 99 dispensed from the device 101, the animal will approach the device 101 and retrieve the food pellets 99 from the trough 106. To solidify the association between the sound and the food pellet 99, the user preferably repeats this procedure by dispensing food pellets 99 as the animal is looking at the device 101. In accordance with one embodiment of the present protocol, the user then preferably activates the device 101 when the animal is looking away from the device 101. The user preferably repeats the procedure until the animal immediately responds to the device 101 and retrieves its food pellet five or more times in a row in accordance with one embodiment of the present protocol. Alternatively, any other amount of repetitions are contemplated.

To further strengthen the association, the user alternatively, or in addition to, positions the animal further away from the device 202 and activates the device 101 until the animal consistently responds immediately to the tone emitted by running to the device 101 to get the food pellet 99. In one embodiment, the user causes the animal to focus on some other object or activity and then activates the device 101 in accordance with one embodiment of the present protocol. If the animal turns attention to the device 101 upon hearing the tone, the animal has sufficiently established the association between the sound and the food pellet being provided in accordance with the training protocol. This established association between the sound emitted and food pellet 99 dispensed by the device 101 is to mark correct behavior and serves as the basis of the training protocol of the present invention.

The present system 100 can be used to prevent the animal from barking or whining while performing the present training protocol. Preferably, the device 101 should dispense pellets 99 only when the animal is quiet. In one embodiment, the user does not activate the device 101 to dispense pellets 99 until the animal is quiet for about five seconds. If the animal remains quiet for another five seconds, the user dispenses another food pellet from the device 101. This process is repeated for ten repetitions in a row in which the animal is quiet for five seconds between feedings. To solidify the association between remaining quiet and receiving a food pellet, the process is preferably repeated until the animal can remain quiet for at least ten seconds. It should be noted that the amount of time and number of repetitions stated above should not be limited and can be any other amount of time and/or number of repetitions.

In accordance with one embodiment of the present protocol, the system 100 is preferably used to engage the animal in a target training procedure in accordance with one embodiment of the present protocol. Target training is the foundation to many exercises and tricks, including, but not limited to, spinning, rolling over, heeling, and somersaulting. Although these exercises are comparatively advanced, target training is preferably introduced early in the present training protocol to serve as intermittent exercises during breaks between substantive fundamental training exercises.

The target training procedure preferably utilizes the targeting wand 200 described above, whereby the animal touches the target 202 to receive a food pellet 99. It is contemplated that any of the embodiments shown in FIGS. 4A-4D are alternatively utilized. The target training method is preferably initiated by orienting the animal to face the device 101 and holding the target 202 close enough to the animal's nose level to allow the animal to reach the target 202 by stretching its neck. In accordance with one embodiment of the present training protocol, to establish an association with seeing the target 202 and receiving a food pellet 99, the user activates the device 101 when the animal reaches out to sniff the target 202 and simultaneously removes the target 202 from the animal's view. The animal should immediately run toward the device 101 and retrieve its food pellet 99. In accordance with one embodiment of the present protocol, the next step of the target training method involves presenting the target 202 far enough from the animal such that it has to take one step to touch the target 202. The device 101 is activated as soon as the animal touches the target 202, whereby the user again immediately removes the target from the animal's view. Preferably, the user further solidifies the connection with the target 202 by repeating this step several times. In accordance with one embodiment of the present protocol, a visual association between the target 202 and the device 101 has been substantially established to the animal once the animal has consistently touched the target 202 nine times out often times in a row. Alternatively, any other amount of repetitions are contemplated.

The target training method can preferably extend the visual association between the target 202 and device 101 with a verbal cue in accordance with one embodiment of the present protocol. Preferably, the user distinctly says “target” or any other appropriate desired word to cause the animal to orient itself toward the user. Upon the animal orienting itself toward the user, the user immediately presents the target 202 to the animal in accordance with one embodiment of the present protocol. Based on the visual association already established between the target 202 and device 101, the animal will recognize and touch the target 202. In response, the user will activate the device 101 to dispense the food pellet 99. This process is repeated several times to establish the verbal association between the word “target” and receiving a food pellet form the device 101. After repeating the target training exercise, the animal will associate that “target” or other desired word is always followed by the presentation of the target 202, whereby it must go and touch the target 202 to receive a food pellet. Although the above description is presented with the user activating the device 101 upon the animal touching the target 202, the wand 200 alternatively automatically activates the device 101 upon sensing the animal touching the target 202.

The first fundamental training exercise in the training protocol of the present invention involves training the animal to lay down or be in a “Down-Stay” position for a desired amount of time. The animal is preferably brought over to its “place” which is in front of the device 101 in accordance with one embodiment of the present protocol. It is preferred that a mat is placed at “the place” to give the animal a visual identification of where its “place” is. In one embodiment, the mat is a regular padded bed, blanket or rug. In another embodiment, the mat is the heat and/or pressure sensitive mat 148 (FIG. 5) discussed above. Alternatively, there is no mat that is utilized to serve as the “place,” but just bare floor or the ground. The “place” is preferably a sufficient distance in front of the device 101 such that the animal can retrieve the food pellets 99 from the trough 106 without having to get up when in the “down” position. The animal is preferably brought to the “place” by walking or targeting the animal thereto. Alternatively, the user may have to lure the animal to the place with a food pellet 99.

In accordance with one embodiment of the present protocol, the animal is cued to lay down at the “place” and be oriented toward the device 101. The animal can be trained to go from a standing or sitting position to the “down” position by the user presenting a food pellet in her hand in front of the animal's nose. This is done by the user gradually moving her hand, and the food pellet, downward toward the ground. As the animal begins to move its head downward to follow the food pellet, the user then moves her hand, along with the food pellet, away from the animal's face and towards the device 101 in a “L” movement. As the food pellet is moved away from the animal's face, the animal will gradually lay down and stretch out its neck to retrieve the food pellet. This process is then repeated by the user along with the command, “down” to train the animal to lay down when given the command.

Once the animal is in the “down” position, the dispenser 101 is activated to dispense a food pellet 99 every two to three seconds for a one minute set. The device 101 can be set to automatically dispense the food pellets 99, whereby the sensors 128A, 128B of the device 101 are activated to sense whether the animal is laying at its place. This is done by the user selecting the Down-Stay selector 402 to the Single-Treat setting and correspondingly sets the sensitivity selector 408 to the appropriate setting. Alternatively, the user manually dispenses the food pellets 99 to the animal by pressing the dispensing button on the remote control 110 every two to three seconds. Alternatively the user does not use the sensor.

The animal may not initially remain in the Down-Stay position on a consistent basis. The user can adjust the Down-Stay selector 402 to the Cue-Dispense setting to provide the user control as to when the food pellets should be dispensed by the device 101 while following the timed dispensing repetitions of the training protocol. The device 101 will emit a separate tone to cue the user to dispense a food pellet 99 to the animal, thereby giving the user the control to dispense the food pellet 99, depending on whether the animal remains laying down. For example only, the device 101 emits a cue tone to the user based on the dispensing rate at which the Treat Rate dial 406 is set, whereby the trainer depresses the dispense button 102 only when the animal is laying down. If the animal gets up from the Down-Stay position, the trainer will not press the dispense button 102 although the device 101 will have just emitted the cue tone. The animal should realize that it had not done something correctly, because the device 101 will not dispense a food pellet 99. Once the animal remains in the down position consistently, the user can adjust the Down-Stay selector 402 to Single-Treat or Multi-Treat and proceed with the training protocol.

The frequency at which the food pellets 99 are dispensed by the device 101 are preferably within the two to three second range to prevent the animal from having a chance to become distracted and get up from its place. After the one minute set is completed, the animal is called off to practice some targeting or other activity for a short period of time. This technique of the present protocol teaches the animal that it must be called off instead of being allowed to get up by its own choice. The “place” process is again repeated for another minute set in accordance with one embodiment of the present protocol. When the animal remains in the laying down position for five one-minute sets in a row, the first step of the lay down procedure is completed in accordance with one embodiment of the present protocol. Alternatively, any other amount of repetitions and/or sets are contemplated.

The “Down-Stay” training procedure of the present protocol involves preferably repeating the above step, whereby the device 101 dispenses a food pellet 99 every three seconds for a one minute set. This step in the “Down-Stay” procedure extends the amount of time that the animal must lay down before receiving the first food pellet 99, which is preferably three seconds. This may be done automatically by the device 101 or manually by the user. At the end of the one-minute set, the user preferably provides the animal a few food pellets from the user's hand while the animal is still lying down. This step of the present protocol trains the animal that it still has to stay down when getting food pellets from the user's hand as well as prevents the animal from becoming possessive and guarding the device 101 from the user. The step in the process is repeated again in three second dispensing intervals for four more sets. Alternatively, any other amount of intervals, repetitions and/or sets are contemplated. When the animal remains in the “down” position for a total of five one-minute sets in a row, the second step in the lay down protocol is completed. In accordance with one embodiment of the present protocol, the user preferably engages the animal in target training in between one-minute sets.

In accordance with one embodiment of the present protocol, the user then adjusts the dispensing rate of the device 101 to dispense food pellets 99 in five second intervals. To further extend the time that the animal must remain in the “down” position, the first food pellet 99 is dispensed after the animal has been in the “down” position for five seconds. This step is preferably executed for five, one-minute sets. Alternatively, any other amount of intervals, repetitions and/or sets are contemplated. At this point in the present protocol, it is preferred that the dispensing of food pellets 99 is done in a varying manner after each one minute set is completed. Preferably the device 101 only dispenses a few food pellets 99 at a variable rate before the user calls the animal from its place. This prevents the animal from anticipating getting up after one minute or standing up as the user approaches the animal to begin the target training exercise.

Following, in accordance with one embodiment of the present protocol, the animal is cued in the “down” position in front of the device while the device 101 dispenses food pellets 99 in seven second intervals for five, one-minute sets. In this step, the first food pellet 99 is dispensed after the animal has been in the “down” position for seven seconds. At this stage, the user may choose to call the animal off its place at the end of the one-minute set, because the animal may anticipate more food pellets 99 to be dispensed from the device 101. The user can then engage the animal in target training. Alternatively, the user engages the animal in target training for a few seconds and then calls the animal off its place. Alternatively, the user calls the animal off its place frequently and gives the animal a food pellet by hand.

The “Down-Stay” step of the present protocol is then preferably repeated for ten second intervals for five, one-minute sets as well as fifteen second intervals for five one-minute sets. As stated above, the animal is to be called from its place in accordance with the protocol, whereby the animal is engaged in target training or some other exercise between sets. Alternatively, any other amount of intervals, repetitions and/or sets are contemplated.

Following, the Down-Stay protocol is preferably repeated, whereby the device 101 is adjusted to dispense at twenty second intervals and increasing the distance between where the animal is sitting and the device 101 to five feet. The procedure is preferably repeated for five, one-minute sets whereby the animal is to be engaged in target training or other exercise between sets. Alternatively, any other amount of intervals, repetitions and/or sets are contemplated.

Once the animal is able to stay in the “down” position for five sets, the protocol is then preferably repeated. The device 101 is preferably adjusted to dispense the food pellets 99 at twenty five second intervals for five, one-minute sets. Once the animal is able to complete five sets lying down, the device 101 is adjusted to dispense food pellets 99 at fifty second intervals for five, one-minute sets. Once successfully completed, the device 101 is adjusted to dispense food pellets at 1 minute intervals for five sets. When the animal is able to lay down for five sets of 1 minute each, the animal has successfully completed the “down-stay” portion of the present training protocol. Alternatively, any other amount of intervals, repetitions and/or sets are contemplated.

Inone embodiment, once the animal is able to stay in the Down-Stay position, the user may choose to reinforce the Down-Stay exercise by manually dispensing several pellets 99 at random intervals. This can be done by pressing and holding the dispense button 102 for a few seconds, whereby the device 101 will dispense several pellets 99 into the trough. Alternatively, the user can set the variable/fixed selector 404 to variable and select the Down-Stay selector 402 to the Multi-Treat setting along with setting the Treat Rate dial 406 to a desired dispensing frequency.

At this point of the present protocol training, the animal will probably know to go to its place when the user walks the animal to its place. However, the animal does not necessarily reliably go its place by itself upon command. Thus, the next fundamental exercise in the present protocol involves training the animal to go to its place upon command by the user. This particular procedure of the present protocol involves training the animal much like the targeting training exercise discussed above. It is preferred that the animal is initially held by the user to be oriented at least ten feet from the device 101. In accordance with the preferred protocol, the user activates the device 101 to dispense a food pellet 99. Upon seeing the food pellet 99, the animal will eagerly try to run to the device 101. Therefore, the user says, “place” or other desired word and immediately releases the animal so that the animal can run to the device 101.

In accordance with the one embodiment of the present protocol, once the animal reaches its place, the user distinctly commands the word, “Down” or any other desired word before the animal gets up from its place. Once the animal lies down at its place, the device 101 is activated to dispense food pellets 99 at regular or variable intervals. Following, the protocol involves calling the animal off its place to return to the user. It is preferred that the food pellets are dispensed by the device 101 at random intervals to further strengthen the “Down” command. This procedure is repeated until the animal is able to run to its place and lie down upon command nine out often times. Alternatively, any other amount of intervals, repetitions and/or sets are contemplated. When the animal can lie down on it own (without a “Down” command) nine out of ten times in a row, the animal is ready for the next step in the present protocol.

At this point of the protocol, the animal preferably knows to run directly to the device 101 and lie down at its place. However, the animal does not necessarily know that it must be standing or lying down to receive its food pellet 99, due to the orientation of a mat positioned at “the place” with respect to the device 101. Thus, the next step of present protocol ensures that the animal is trained to go to the mat instead of the device 101 when the “Place” command is given. In accordance with the present protocol, the device 101 is moved at a 45-90° angle with respect to the mat. If a mat 148 is not used in the training protocol, a mat 148 should be used and positioned at the animal's “place” for this exercise. Alternatively, or in addition to, the device 101 is moved a further distance away from the mat. In accordance with one embodiment of the present protocol, the “Place” command is given and the animal runs to the mat. However, the animal may run straight to the device 101 and ignore the mat, wherein the animal should be given the opportunity to step onto the mat. After noticing that the food pellet 99 is not being dispensed by the device 101, the animal will probably move to the mat. Once the animal is on the mat, the “Down” command is preferably given, whereby a food pellet 99 is dispensed by the device 101 once the animal lies down. When the animal preferably performs this step nine out often times in a row, the protocol is repeated whereby the mat and device 101 are oriented in a different manner (e.g. switching places between the mat and device 101). After the animal preferably performs this step nine out often times in a row, the training proceeds to the next step in the protocol. Alternatively, any other amount of intervals, repetitions and/or sets are contemplated.

The preceding step in the present training protocol trains the animal to go to a designated area and lie down in that area. The training protocol of the present invention further expands the training to teach the animal to remain lying down with distractions. In accordance with one embodiment of the present protocol, it is preferred that the mat, if used, is placed at its final location within the home, such that the animal learns to go to the final location when the “Place” command is given. It is preferred that the final location be placed within visual range of the door for the animal, otherwise placing the device 101 or mat 148 in another room may cause the animal's curiosity to overcome its trained behavior. Alternatively, the final location is any other location inside or outside of the home.

For the “distraction” portion of the training procedure, it is preferred that the animal is commanded to go to its “place,” which is between 5-10 feet away from where the animal is initially oriented, to further practice the “place and down” training. In accordance with one embodiment of the present protocol, the user begins walking around the animal once the animal is lying down at its place. It is preferred that initially the movements are close to the animal and not too sudden to startle the animal and cause the animal to get up. As the user walks around the animal, the device 101 preferably dispenses food pellets 99 every two to three seconds. In accordance with the protocol, the user walks around the animal at a further distance and starts making more erratic moves, including, but not limited to, jerking movements, stopping and starting, and walking toward the door and back. In accordance with one embodiment of the present protocol, it is preferred that the more difficult moves are performed by the user as the animal is taking a food pellet from the trough 106. This process is preferably repeated for three one-minute sets, whereby the animal is called off its place between sets for targeting or other exercises. After the animal satisfactorily remains in place for all three sets in a row, the training proceeds to the next step in the protocol. Alternatively, any other amount of intervals, repetitions and/or sets are contemplated.

In accordance with the present protocol, the distraction procedure is further expanded whereby the user incorporates short quick movements and running, along with walking, around the animal. It is preferred that the movements are timed as the animal is retrieving the food pellets 99 from the trough 106. Once the animal is no longer excited or interested in the quick movements or running, the user preferably times the quick movements immediately before the device 101 dispenses a food pellet. As the animal remains calm and lying in its place, the food pellets 99 are dispensed in a more random manner while the user continues the combined movements. In accordance with one embodiment of the present protocol, the user is encouraged to perform additional movements (e.g. dancing, leaning over, sitting) which the user knows usually distracts the animal. This process should be repeated for three one-minute sets, whereby the animal is called from its place between sets for targeting or other exercise. After the animal satisfactorily remains in place for all three sets in a row, the training proceeds to the next step in the protocol. Alternatively, any other amount of intervals, repetitions and/or sets are contemplated.

In accordance with the present protocol, the distraction procedure is further expanded, whereby the user incorporates loud sounds and taking to the animal while walking around the animal. Such sounds include, but are not limited to, yelling, cheering, and howling. It is preferred that the sounds are timed to be given by the user as the animal is retrieving the food pellets 99 from the trough 106. Once the animal is no longer excited or interested in the loud sounds, the user times the loud sounds to occur immediately before the device 101 dispenses a food pellet. As the animal remains calm and lying at its place, the food pellets 99 are dispensed in a more random manner while the user continues to make the loud sounds. This process should be repeated for three one-minute sets, whereby the animal is called off between sets for targeting or other exercise. After the animal satisfactorily remains in place for all three sets in a row, the training proceeds to the next step in the protocol. Alternatively, any other amount of intervals, repetitions and/or sets are contemplated.

In accordance with the present protocol, the distraction procedure is further expanded whereby the user incorporates a toy (e.g. a squeaky ball) in an attempt to desensitize the animal to distractions. This step in the present protocol is optional in accordance with the present protocol if the animal is not distracted by toys. In this step in the training protocol, the user stands a certain distance away from the animal and the device 101 (e.g. ten feet) and squeaks the toy or drops the toy on the ground as the animal retrieves the food pellet 99 from the trough 106. This process should be repeated for two one-minute sets, whereby the animal is called off between sets for targeting or other exercise. Alternatively, any other amount of intervals, repetitions and/or sets are contemplated.

After the animal satisfactorily remains in place for both sets, the user squeaks the toy or bounces the ball at random intervals in accordance with the present protocol for two one-minute sets. Alternatively, any other amount of intervals, repetitions and/or sets are contemplated. After the animal preferably satisfactorily remains in place for both sets, the user squeaks the toy or bounces the ball as the animal is retrieving the food pellets 99 at a distance closer to the animal (e.g. five feet) for two one-minute sets. After the animal remains in place for both sets, the user squeaks the toy or bounces the ball at random intervals for two one-minute sets while in accordance with the present protocol. After the animal remains in place for both sets, the training proceeds to the next step in the protocol. Alternatively, any other amount of intervals, repetitions and/or sets are contemplated.

In accordance with the present protocol, the user incorporates walking to the door and knocking on the door as the animal is lying down at its place. It is preferred that the knocking is timed as the animal is retrieving the food pellets 99 from the trough 106. Once the animal is no longer excited or interested in the knocking, the present protocol includes knocking on the door more loudly. This process should be repeated for two one-minute sets, whereby the animal is called off between sets for targeting or other exercise. After the animal remains in place for both sets, the training proceeds to the opening and closing the front door in accordance with the protocol. Alternatively, any other amount of intervals, repetitions and/or sets are contemplated.

In accordance with the distraction procedure of the present protocol, the user incorporates opening and closing the door as the animal is lying down at its place. Depending on the sensitivity of the animal, the present protocol contemplates touching the door knob or rattling the lock at the same time that the animal retrieves food pellets 99 from the trough 106. In addition, the present protocol contemplates gradually opening and closing the door at the same time that the animal retrieves food pellets 99 from the trough 106. Once the animal remains down while the door is fully opened and closed for two one-minute sets, the user opens the door, walks outside and eventually rings the doorbell in accordance with one embodiment of the present protocol. Alternatively, any other amount of intervals, repetitions and/or sets are contemplated. If the animal remains lying down for both sets, the training protocol proceeds to the next step.

The next step of the distraction procedure of the present protocol instructs the user to combine all of the distractions from the previous steps while setting the device 101 to dispense food pellets at a set rate for two one-minute sets. Alternatively, any other amount of intervals, repetitions and/or sets are contemplated. It is preferred that the rate at which the device 101 dispenses food pellet is decreased after every set. Therefore, in accordance with one embodiment of the present protocol, the device 101 dispenses food pellets 99 every five seconds for the first two one-minute sets; then every seven seconds for the next two one-minute sets; then every ten seconds; 15 seconds, 20 seconds, 30 seconds, 45 seconds, 1 minute and finally, at 5 minute intervals. Once the animal is able to remain in the “down” position for five minutes, the animal has successfully completed the distraction procedure of the present protocol.

In addition to the above procedures, the present system 100 and protocol are also able to train the animal to look up at the user upon command. For instance, the user places the animal near the device 101 and begins calling the animal's name or making a sound (e.g. a smooching sound). Once the animal looks to the user upon making the sound, the user immediately activates the device 101. This procedure is preferably repeated until the animal learns to look at the user immediately after the user makes the sound nine out of ten times in a row.

The foregoing description of preferred embodiments of the present invention has been provided for the purposes of illustration and description. It is not intended to be exhaustive or to limit the invention to the precise forms disclosed. Many modifications and variations will be apparent to one of ordinary skill in the relevant arts. The embodiments were chosen and described in order to best explain the principles of the invention and its practical application, thereby enabling others skilled in the art to understand the invention for various embodiments and with various modifications that are suited to the particular use contemplated. It is intended that the scope of the invention be defined by the claims and their equivalence.

1. A system to train an animal comprising:
a. a device having a food container and a receptacle in communication with the food container, the device including a receiving sensor; and
b. a handheld remote control having a transmitter configured to transmit a dispensing signal to the receiving sensor of the device, wherein the device dispenses one or more food pellets from the food container to the receptacle upon receiving the dispensing signal.

2. The system according to claim 1 wherein the device further comprises a chute to allow food to pass from the food container to the receptacle.

3. The system according to claim 1 wherein the device further comprises a rotatable disk positioned between the food container and a chute, wherein the disk includes at least one aperture configured to deposit food pellets from the food container into the chute when aligned therewith.

4. The system according to claim 3 wherein the device further comprises a motor coupled to the disk, wherein the motor selectively rotates the disk about an axis.

5. The system according to claim 1 wherein the device further comprises a speaker adapted to emit a sound when dispensing the one or more food pellets

6. The system according to claim 5 wherein the device further comprises a volume control coupled to the speaker.

7. The system according to claim 1 wherein the device is configured to automatically dispense the food pellets at a desired dispensing rate.

8. The system according to claim 1 wherein the remote control is configured to selectively operate the device between a manual dispensing mode and an automatic dispensing mode.

9. The system according to claim 1 wherein the device is configured to automatically dispense the food pellets at a random dispensing rate.

10. The system according to claim 1 wherein the device further comprises a lid coupled to the food container, wherein the lid at least covers the food container.

11. The system according to claim 1 wherein the device further comprises a lid coupled to the food container, wherein the lid selectively covers the food container and a control panel.

12. The system according to claim 1 wherein the device further comprises a lid removably coupled to the food container, the lid including a handle on an underside to utilize the lid as a food scooping device.

13. The system according to claim 1 wherein the remote control further comprises a wand having a touch pad.

14. The system according to claim 1 wherein the remote control further comprises a wand having a touch pad, wherein the dispensing signal is transmitted upon the touch pad sensing pressure thereon.

15. The system according to claim 1 further comprising a wand adapted to be used in association with the device, wherein the wand includes a touch pad.

16. The system according to claim 15 wherein the wand is adapted to be telescopically actuatable between an extended position and a retracted position.

17. The system according to claim 15 wherein the wand is adapted to be removably coupled to a base.

18. The system according to claim 15 wherein the wand further comprises a touch sensor within the touch pad and a wand transmitter coupled to the touch sensor, wherein the wand transmitter transmits the dispensing signal to the receiving sensor of the device upon the touch sensor sensing contact with the touch pad.

19. The system according to claim 1 wherein the device is configured to automatically dispense food pellets upon sensing the animal sitting substantially in front of the device.

20. The system according to claim 1 wherein the device is configured to undergo standby mode after a set amount of time of non-activity.

21. The system according to claim 1 wherein the receptacle is elongated such that the device is capable of dispensing food pellets from a height above the animal.

22. The system according to claim 1 wherein the device further comprises a control panel to adjust one or more operating settings of the device.

23. The system according to claim 22 wherein the control panel further comprises a switch to selectively turn the device between an on state and an off state.

24. The system according to claim 22 wherein the control panel further comprises a switch to selectively adjust the device between dispensing a single treat and dispensing multiple treats upon the device receiving the dispensing signal.

25. The system according to claim 22 wherein the control panel further comprises a switch to selectively adjust the device to operate in a Cue-Dispense setting.

26. The system according to claim 22 wherein the control panel further comprises a switch to selectively adjust a dispensing rate of the device.

27. The system according to claim 22 wherein the control panel further comprises a switch to selectively adjust a sensitivity of an animal sensor, wherein the animal sensor senses whether an animal is present in front of the device.

28. The system according to claim 22 wherein the control panel further comprises a switch to selectively adjust a speaker volume of the device.

29. The system according to claim 22 wherein the control panel further comprises a switch to selectively adjust the device to operate between a fixed dispensing rate and a variable dispensing rate.

30. The system according to claim 1 wherein the device is adapted to selectively emit a tone for the user to manually dispense the one or more food pellets.

31. The system according to claim 1 wherein the device further comprises a light.

32. The system according to claim 1 wherein the device further comprises a pad coupled thereto, wherein the pad is configured to sense whether the animal is present in front of the device.

33. The system according to claim 1 wherein the device further comprises a sensor to sense whether the animal is present in front of the device.

34. The system according to claim 33 wherein a sensitivity setting of the sensor is selectivity adjustable.

35. The system according to claim 33 wherein the sensor is configured to identify an authorized animal from an unauthorized animal, wherein the device dispenses food pellets only to the authorized animal.

36. The system according to claim 35 wherein the sensor utilizes a RFID communication protocol.

37. The system according to claim 1 wherein a dispensing rate of the device is selectively adjustable.

38. The system according to claim 3 wherein the rotatable disk further comprises at least one rib extending therefrom, wherein the rib agitates food pellets in the food container as the disk rotates.

39. The system according to claim 3 wherein the rotatable disk further comprises at least one protrusion extending therefrom, wherein the protrusion agitates food pellets in the food container as the disk rotates.

40. The system according to claim 3 wherein the rotatable disk further comprises a groove associated with the at least one aperture, wherein the groove guides food pellets to the aperture as the disk rotates.

41. The system according to claim 3 further comprising an ejecting mechanism located in the food container and configured to eject a food pellet from the aperture of the disk upon the aperture passing over the ejecting mechanism.

42. The system according to claim 1 wherein the device further comprises an external food container adapted to be removably coupled thereto.

43. The system according to claim 1 wherein the device further comprises a camera.

44. The system according to claim 1 wherein the device further comprises a communication port, wherein the device is capable of being operated remotely.

45. The system according to claim 1 wherein the device further comprises a dispensing sensor, wherein the dispensing sensor senses the food pellet being dispensed by the device.

46. The system according to claim 2 wherein the device further comprises a dispensing sensor within the chute, wherein the dispensing sensor senses the food pellet being dispensed by the device.

47. The system according to claim 1 wherein the device further comprises a dispensing sensor in the receptacle to sens the food pellet in receptacle.

48. The system according to claim 1 wherein the device dispenses a plurality of food pellets upon receiving a continuous dispensing signal from the remote control.

49. The system according to claim 1 wherein the device is portable.

50. The system according to claim 1 wherein the device is adapted to be operable in a vehicle.

51. The system according to claim 1 wherein the device is adapted to be handheld.

52. An animal training device comprising:
a. a body having a chute;
b. a food container in communication with the chute; and
c. a dispensing mechanism configured to selectively deposit a food pellet into the chute upon the device receiving a dispensing signal from a handheld remote control.

53. The device according to claim 52 further comprising a speaker to emit a sound upon the device receiving the dispensing signal.

54. The device according to claim 52 further comprising a receiving sensor adapted to receive the dispensing signal from the handheld remote control.

55. The device according to claim 52 wherein the dispensing mechanism further comprises a rotatable disk coupled to the body, wherein the disk includes at least one aperture configured to deposit the food pellet from the food container into the chute when aligned therewith.

56. The device according to claim 55 wherein the device further comprises a motor coupled to the disk, wherein the motor selectively rotates the disk about an axis.

57. The device according to claim 53 further comprising a volume control switch coupled to the speaker.

58. The device according to claim 52 wherein the dispensing mechanism is configured to automatically dispense the food pellet at a desired dispensing rate.

59. The device according to claim 58 wherein a dispensing rate is selectively adjustable.

60. The device according to claim 52 wherein the dispensing mechanism is configured to automatically dispense the food pellet randomly.

61. The device according to claim 52 wherein the device further comprises a control panel to adjust one or more operating settings of the device.

62. The device according to claim 52 wherein the device is adapted to selectively emit a tone for the user to manually dispense the food pellet.

63. The device according to claim 52 further comprising a light.

64. The device according to claim 52 further comprising a sensor to sense whether the animal is present in front of the device, the sensor having a desired sensitivity.

65. The device according to claim 64 wherein the sensitivity of the sensor is selectivity adjustable.

66. The device according to claim 64 wherein the sensor is configured to identify an authorized animal from an unauthorized animal, wherein the device dispenses food pellets only to the authorized animal.

67. The device according to claim 55 wherein the disk further comprises at least one rib extending therefrom, wherein the rib agitates the food pellet in the food container as the disk rotates.

68. The system according to claim 55 wherein the rotatable disk further comprises at least one protrusion extending therefrom, wherein the protrusion agitates food pellets in the food container as the disk rotates.

69. The device according to claim 55 wherein the disk further comprises a groove associated with the at least one aperture, wherein the groove guides the food pellet to the aperture as the disk rotates.

70. The device according to claim 55 further comprising an ejecting mechanism located in the food container and configured to eject the food pellet from the aperture of the disk upon the aperture passing over the ejecting mechanism.

71. The device according to claim 52 further comprising an external food container adapted to be removably coupled thereto.

72. The device according to claim 52 further comprising a camera.

73. The device according to claim 52 further comprising a communication port, wherein device is capable of being operated remotely over a network.

74. The device according to claim 52 further comprising a dispensing sensor, wherein the dispensing sensor senses the food pellet being dispensed by the device.

75. The device according to claim 52 wherein the device dispenses a plurality of food pellets upon receiving a continuous dispensing signal from the remote control.

76. The device according to claim 52 wherein the device is portable.

77. The device according to claim 52 wherein the device is adapted to be operable in a vehicle.

78. The device according to claim 52 wherein the device is adapted to be handheld.

79. The device according to claim 52 wherein the device undergoes standby mode after a set amount of time of non-activity.

80. A method of training an animal comprising the steps of:
a. selecting a food dispensing device adapted to dispense a food pellet and emit a tone upon receiving a dispensing signal from a remote controlled device;
b. commanding the animal to perform an act; and
c. rewarding the animal upon performing the act by selectively operating the food dispensing device to dispense the food pellet.

81. The method according to claim 80 wherein the food is dispensed and the tone is emitted at substantially the same time after receiving the dispensing signal

82. The method according to claim 80 training the animal to retrieve one or more food pellets from the food dispensing device upon the animal hearing the tone.

83. The method according to claim 82 wherein the act further comprises training to touching a target, wherein the food dispensing device is activated after the animal touches the target.

84. The method according to claim 83 wherein training to touch the target further comprises removing the target from the view of the animal upon activating the device.

85. The method according to claim 83 wherein training to touch the target further comprises stating at least one desired word prior to presenting the target to the animal.

86. The method according to claim 80 wherein the act further comprises the animal in a down position at a desired location in front of the device.

87. The method according to claim 80 wherein the step of selectively activating further comprises manually activating the food dispensing device by the remote control.

88. The method according to claim 80 wherein the step of selectively activating further comprises automatically dispensing the food pellets at a desired dispensing rate.

89. A method of training an animal utilizing positive reinforcement comprising:
a. selecting a food dispensing device configured to emit a tone and dispense a food pellet upon receiving a transmitted signal from a remotely controlled device;
b. establishing an association between hearing the emitted tone and retrieving a dispensed food pellet; and
c. instructing the animal to execute an act, wherein the animal is rewarded upon executing the act by activating the food dispensing device.

90. A device configured to dispense food pellets in conjunction with a positive reinforcement training protocol, the device comprising:
a. a body having a chute;
b. a food container in communication with the chute; and
c. a rotatable disk configured to selectively dispense at least one food pellet from the food container to the chute outlet.

91. A device configured to dispense food pellets in conjunction with a positive reinforcement training protocol, the device comprising:
a. a body having a chute;
b. a food container in communication with the chute inlet;
c. a dispensing mechanism configured to selectively dispense a food pellet into the chute; and
d. a speaker configured to emit a sound at substantially simultaneously with the dispensing mechanism operating.

92. A handheld remote control adapted to be used in training an animal utilizing a food dispensing device in accordance with a positive reinforcement training protocol, the remote control comprising:
a. a body having a transmitter located therein;
b. a circuit coupled to the transmitter; and
c. a first button in the body and coupled to the circuit, wherein the transmitter transmits a dispensing signal to the food dispensing device upon the first button being depressed.

93. The remote control according to claim 92 further comprising a second button in the body and coupled to the circuit, wherein the transmitter transmits a cue-dispense signal to the food dispensing device such that the food dispensing device operates in a cue-dispense setting upon receiving the cue-dispense signal.

94. The remote control according to claim 92 further comprising a touch pad located on an end of the body, the touch pad adapted to be touched by the animal.

95. The remote control according to claim 94 wherein the touch pad is telescopically movable between a retracted position and an extended position with respect to the body.

96. The remote control according to claim 92 wherein the touch pad includes a sensor within configured to sense pressure, wherein the transmitter sends the dispensing signal to food dispensing device upon sensing pressure.

97. An animal training device comprising:
a. a body having a chute;
b. a food container in communication with the chute;
c. an animal sensor adapted to sense whether an animal is present in front of the device; and
d. a dispensing mechanism configured to selectively deposit a food pellet into the chute upon the animal sensor sensing the animal present in front of the device.

98. An animal training device comprising:
a. a body having a chute;
b. a food container in communication with the chute;
c. a dispensing mechanism configured to selectively deposit a food pellet into the chute; and
d. a dispensing sensor within the body adapted to sense whether the food pellet is deposited in the chute, wherein the dispensing mechanism is instructed to continually dispense food pellets until a desired number of food pellets are sensed by the dispensing sensor.

99. An animal training device comprising:
a. a body having a chute;
b. a food container in communication with the chute;
c. an animal sensor adapted to sense whether an animal is present in front of the device utilizing RFID communication technology; and
d. a dispensing mechanism configured to selectively deposit a food pellet into the chute upon the animal sensor sensing the animal present in front of the device.
